(19) United States
(12) Patent Application Publication
(10) Pub. No.: US 2026/0156113 A1
(43) Pub. Date: Jun. 4, 2026

(54) Trust Based Access Control in Communication Network

(71) Applicant: Telefonaktiebolaget LM Ericsson (publ), Stockholm (SE)

(72) Inventors: Jonathan Olsson, Sollentuna (SE); Patrik Teppo, Bobäck (FI)

(21) Appl. No.: 19/105,938

(22) PCT Filed: Aug. 26, 2022
(86) PCT No.: PCT/SE2022/050770

§ 371 Date: Feb. 24, 2025

(51) Int. Cl. H04L 9/40; H04L 41/40

(52) U.S. Cl. CPC H04L 63/10; H04L 41/40; H04L 63/0823

(57) ABSTRACT

A method performed by a first network node (104) is disclosed. The method comprises receiving a request message comprising a request for authorizing and/or authenticating and/or evaluating trust of a first network function NF, device (101). The method comprises obtaining, from a trust measurement function, TMF (103), a trust score for the first NF device. The method further comprises, sending a response message comprising an access control decision for the first NF device (101), wherein the access control decision is determined based on at least the trust score; or the method further comprises, sending a response message indicating the trust score of the first NF device for enabling a determination of an access control decision based on at least the trust score. In one or more embodiments, the response message is sent to establish a connection between the first NF device (101) and a second NF device (102).

### TECHNICAL FIELD

The present disclosure relates to trust-based access control mechanisms in a communication network.

### BACKGROUND

The Third Generation Partnership Project (3GPP) networks, e.g. Fifth Generation (5G) network, typically utilize security on all the specified interfaces. The interfaces use authentication, e.g. mutual authentication, and data protection, e.g. encryption and integrity protection, mechanisms. Some interfaces like in the 5G core network also use authorization based on policies configured in a Network function Repository Function (NRF). Such controls mitigate many security risks, but there is still a need for new and/or improved security solutions for access control.

Furthermore, introducing new security functionality and parameters in a 3GPP network is not straight forward since the interfaces in the 3GPP network utilize standardised protocols. A possible approach is to add new interfaces on a Network Function (NF) for communicating new security functionalities and parameters. However, such an approach would go against the 3GPP standard implementation which employs standardized interfaces.

### SUMMARY

An object of the present disclosure is to improve security in a communication network.

To achieve the object, according to a first aspect, there is provided a method performed by a first network node. The method comprises receiving a request message comprising a request for authorizing and/or authenticating and/or evaluating trust of a first network function, NF, device. The method comprises obtaining, from a trust measurement function, TMF, a trust score for the first NF device. The method further comprises sending a response message comprising an access control decision for the first NF device, wherein the access control decision is determined based on at least the trust score; or the method further comprises sending a response message indicating the trust score of the first NF device for enabling a determination of an access control decision based on at least the trust score.

In an embodiment according to the first aspect, the request message is received before connection establishment between the first NF device and a second NF device, and the access control decision is used to establish a secure connection between the first NF device and the second NF device.

In an embodiment according to the first aspect, the request message is received after connection establishment between the first NF device and a second NF device, and the access control decision is used to establish a secure connection between the first NF device and the second NF device.

In an embodiment according to the first aspect and the one or more embodiments above, the method comprises obtaining the access control decision from a second network node.

In an embodiment according to the first aspect and the one or more embodiments above, the access control decision indicates that the first NF device is authenticated and/or authorized and/or trusted.

In an embodiment according to the first aspect and the one or more embodiments above, the access control decision indicates that the first NF device is not authenticated and/or not authorized and/or not trusted.

In an embodiment according to the first aspect and the one or more embodiments above, the response message is sent to establish a connection between the first NF device and a second NF device.

In an embodiment according to the embodiment above, the access control decision is indicated via a flag certificateHold.

In an embodiment according to the first aspect and the one or more embodiments above, the first network node is an Online Certificate Status Protocol, OCSP, or a Certificate Revocation List, CRL, server.

In an embodiment according to the first aspect and the one or more embodiments above, the method comprises obtaining the access control decision from a second network node, wherein the second network node is Policy Enforcement Function, PEF.

In an embodiment according to the first aspect and the one or more embodiments above, sending the response message comprises sending the response message via an access control procedure using at least a public key infrastructure, PKI, certificate.

In an embodiment according to the first aspect and the one or more embodiments above, the first network node is a Network Repository Function, NRF, wherein the request message is received from the first NF device, and wherein the response message is sent to the first NF device.

In an embodiment according to the first aspect and the one or more embodiments above, sending the response message comprises sending the response message via an access control procedure using OAuth 2.0, wherein the response message comprises an access token for the first NF device.

In an embodiment according to the first aspect and the one or more embodiments above, the first network node is an Internet Protocol Security, IPSec, gateway.

In an embodiment according to the first aspect and the one or more embodiments above, the method comprises obtaining the access control decision from a second network node wherein the second network node is a Radius server or a Lightweight Directory Access Protocol, LDAP, server.

In an embodiment according to the first aspect and the one or more embodiments above, sending the response message comprises sending the response message via an access control procedure using Internet Key Exchange, IKE, authentication and authorization.

In an embodiment according to the first aspect and the one or more embodiments above, the first network node is a Radius server or a Lightweight Directory Access Protocol, LDAP, server.

In an embodiment according to the first aspect and the one or more embodiments above, sending the response message comprises sending the response message via an access control procedure using Operation and Management, OAM, procedure.

In an embodiment according to the first aspect and the one or more embodiments above, the trust score is determined based on at least one of: analysis of different logs of the first NF device, boot measurement, attestation state and Endpoint Detect Response, EDR.

In an embodiment according to the first aspect and the one or more embodiments above, the trust score of the first NF device is determined based on measurement data of the first NF device.

According to a second aspect, there is provided a method performed by a network function, NF, device. The method comprises sending, to a first network node, a request message comprising a request for authenticating and/or authorizing and/or evaluating trust of a first NF device. The method comprises receiving, from the first network node, a response message indicating a trust score for the first NF device. The method comprises establishing a connection based on an access control decision determined using the trust score.

In an embodiment according to the second aspect, the method comprises determining the access control decision based on at least the trust score.

In an embodiment according to the second aspect and the one or more embodiments of the second aspect above, the method comprises sending, to a trust measurement function, measurement data for determining the trust score.

In an embodiment according to the second aspect and the one or more embodiments of the second aspect above, the response message comprises the access control decision.

In an embodiment according to the second aspect and the one or more embodiments of the second aspect above, the access control decision indicates that the first NF device is authenticated and/or authorized and/or trusted.

In an embodiment according to the second aspect and the one or more embodiments of the second aspect above, the access control decision indicates that the first NF device is not authenticated and/or not authorized and/or trusted.

In an embodiment according to the second aspect and the one or more embodiments of the second aspect above, the access control decision is indicated via a flag certificateHold.

In an embodiment according to the second aspect and the one or more embodiments of the second aspect above, the first network node is an Online Certificate Status Protocol, OCSP, or a Certificate Revocation List, CRL, server.

In an embodiment according to the second aspect and the one or more embodiments of the second aspect above, the first network node is an Internet Protocol Security, IPSec, gateway.

In an embodiment according to the second aspect and the one or more embodiments of the second aspect above, the first network node is a Radius server or a Lightweight Directory Access Protocol, LDAP, server.

In an embodiment according to the second aspect and the one or more embodiments of the second aspect above, the trust score is determined based on at least one of: analysis of different logs of the NF, boot measurement, attestation state and Endpoint Detect Response, EDR.

In an embodiment according to the second aspect and the one or more embodiments of the second aspect above, the trust score of the first NF device is determined based on measurement data of the first NF device.

In an embodiment according to the second aspect and the one or more embodiments of the second aspect above the NF device is the first NF device or a second NF device.

According to a third aspect, there is provided a first network node comprising a memory and a processor. The memory contains instructions which when executed on the processor cause the first network node to receive a request message comprising a request for authorizing and/or authenticating and/or evaluating trust of a first NF device; obtain from a trust measurement function, TMF, a trust score for the first NF device; wherein the instructions when executed on the processor further cause the first network node to: send a response message comprising an access control decision for the first NF device, wherein the access control decision is determined based on at least the trust score; or send a response message comprising the trust score for the first NF device for enabling determination of an access control decision based on at least the trust score.

In an embodiment according to the third aspect, the memory contains instructions which when executed on the processor cause the first network node to perform the method according to any one of embodiments of the first aspect.

According to a fourth aspect, there is provided a network function device, NF, comprising a memory and a processor. The memory contains instructions which when executed on the processor cause the NF device to: send to a first network node a request message comprising a request for authenticating and/or authorizing and/or evaluating trust of a first NF device; receive from the first network node, a response message indicating a trust score of the first NF device; and establish a connection based on an access control decision determined using the trust score.

In an embodiment according to the fourth aspect, the memory contains instructions which when executed on the processor cause the NF device to perform a method according to any one of embodiments of the second aspect.

According to a fifth aspect, there is provided a computer program, comprising instructions which, when executed on a first network node, cause the first network node to carry out the method according to any one of the first aspect and one or more embodiments of the first aspect.

According to a sixth aspect, there is provided a computer program product, CPP, comprising a computer readable storage means on which the computer program according to the fifth aspect is stored.

According to a seventh aspect, there is provided a computer program, comprising instructions which, when executed on a network function device, cause the network function device to carry out the method according to any one of the second aspect and one or more embodiments of the second aspect.

According to an eighth aspect, there is provided a computer program product, CPP, comprising a computer readable storage means on which the computer program according to the seventh aspect is stored.

An advantage of one or more embodiments of the invention is utilization of Zero Trust Architecture (ZTA) paradigm to enhance security control by measuring and verifying trust of different NFs in the communication network.

Another advantage of one or more embodiments of the invention is to improve security by including trust measurement information, in addition to authentication and/or authorization, for access control decision making in relation to connection establishment between two NFs.

Yet another advantage of one or more embodiments of the invention is utilizing existing 3GPP interfaces to send the trust information enabling easy integration and simple deployment of the proposed solution.

### BRIEF DESCRIPTION OF THE DRAWINGS

FIG. 1 is a signalling diagram illustrating interaction between entities in a system according to an embodiment.

FIG. 2 illustrates a system comprising an OCSP/CRL server and a second network node/PEF according to a first embodiment.

FIG. 3 illustrates a system comprising an NRF or OAuth 2.0 server according to a second embodiment.

FIG. 4 illustrates a system comprising an IPsec SEG and a second network node/Radius or LDAP server according to a third embodiment.

FIG. 5 illustrates a system comprising a Radius/LDAP server according to a fourth embodiment.

FIG. 6 illustrates a method performed by a first network node according to an embodiment.

FIG. 7 illustrates a method performed by a network function device, e.g. a first network function device or a second network function device, according to an embodiment.

FIG. 8 illustrates a first network node according to an embodiment.

FIG. 9 illustrates a network function device, e.g. a first network function device or a second network function device, according to an embodiment.

FIG. 10 illustrates a first network node according to an embodiment.

FIG. 11 illustrates a network function device, e.g. a first network function device or a second network function device, according to an embodiment.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

As described above, 3GPP networks, e.g. 5G network, typically utilize security on all the specified interfaces. The interfaces use authentication, e.g. mutual authentication, and data protection, e.g. encryption and integrity protection, mechanisms. Some interfaces like in the 5G core network also use authorization based on policies configured in a Network function Repository Function (NRF). Such controls mitigate many security risks, but still assume some implicit trust in entities requesting resources with valid credentials. Zero Trust Architecture (ZTA) is a security paradigm that eliminates implicit trust in any one element, node, or service and instead requires continuous verification of the operational procedures. The continuous verification may include interacting with real-time information from multiple sources to determine access and other system responses. In essence, the ZTA allows users access but only to the bare minimum they need to perform their tasks. The ZTA security model assumes that a breach is inevitable or has likely already occurred. For this reason, the ZTA security model limits access to only what is needed while looking for anomalous or malicious activity. The ZTA embeds comprehensive security monitoring, evaluates the trust of subjects accessing resources, performs granular risk-based access controls, and enables a system security automation in a coordinated manner throughout all aspects of the infrastructure. This enables protecting data in real-time within a dynamic threat environment. Such a data-centric security model allows aspects of least-privileged access and dynamic access control to be applied for every access decision, wherein the answers to the questions of who, what, when, where, and how are critical for appropriately allowing or denying access to resources based on the combination of several security attributes and conditions.

It is proposed herein to use and extend existing security services like the Online Certificate Status Protocol (OCSP), Certificate Revocation Lists (CRL), authentication and authorization servers used by Internet Protocol Security (IPSec) Gateways (GWs), and the NRF to implement zero trust access controls to support dynamic access control decisions. At least some of the embodiments present herein address one or more issues, for example, reducing (or even avoiding) impact in the existing standard interfaces and/or reducing adverse impact on one or more functionalities of RAN and core network functions of a communication network, e.g. a 5G network.

The zero trust access controls may be added to functions that are already measuring trust, for example, as defined by 3GPP. These functions may, for example, include a Certification Authority (CA) or a Validation Authority (VA) for verifying the revocation status of client and server certificates before establishing IPsec tunnels or Transport Layer Security (TLS) sessions. Another example is a core network NF such as the NRF, that is responsible for authenticating an NF and authorising requests when issuing access tokens. The NRF can use additional information from other ZTA controls, such as evaluated trust, when evaluating authorisation decisions. This makes the solution easy to implement and integrate into the existing 3GPP standard.

An example is briefly described herein in relation to secure connection establishment according to, for example, the 3GPP standard document TS 33.310 V 17.3.0 (2022-06). TLS flow procedure is described based on the TLS handshake protocol as described in, for example, RFC 8446.

Suppose that a secure connection establishment procedure is performed between a TLS client and a TLS server. The procedure is typically performed as follows:
During initiation of connection establishment, the TLS client sends a ClientHello message to the TLS server message.
The TLS server responds with a ServerHello message followed by a CertificateRequest message, and other additional messages depending on the TLS version and options.
The TLS client responds with a Certificate message containing the TLS client's certificate (or certificate chain) that was issued by the TLS client's Certification Authority.
The TLS server receives the messages from the TLS client and checks the validity of the TLS client's certificate by a revocation check to a CRL database or an OCSP server.
If the revocation check is not successful, the TLS handshake/connection establishment procedure is aborted. If on the other hand, the revocation check is successful, secure connection is established between the TLS client and the TLS server.

The existing certificate validation procedures, as the one described above, do not include performing trust evaluations and/or including trust evaluation information, of e.g. the TLS client, based on ZTA for enabling secure connection establishment.

It is, therefore, proposed herein to perform trust evaluation or include trust-based evaluation metric(s) to enable secure connection establishment between two communicating entities, according to one or more embodiments. Considering the above example of a typical secure connection establishment procedure, in addition to the certificate validation check or as part of the certificate validation check, the procedure further includes evaluating trust level of the TLS client. The trust level may be evaluated based on measurement data such as attestation level, Endpoint Detect Response (EDR) information and other metadata to determine if the TLS client complies with relevant security policies. The trust evaluation may be performed by a Trust Measurement Function or by any network node that is validating the certificate of the TLS client. Based on the trust evaluation, the TLS client may be determined to be trusted or not trusted. In the case that the TLS client is determined as not trusted, the TLS client's certificate may be revoked and connection establishment may be aborted. On the other hand, if the TLS client is determined to be trusted, the secure connection is established between the TLS client and the TLS server.

It will be appreciated that although the above example procedure has been described in the context of a TLS connection establishment, the proposed invention may be applicable in the context of other mechanisms like IPSec/Internet Key Exchange (IKE) as will be described later in this application.

Thus, it is proposed herein to use existing devices or nodes or systems included in identity validation and/or authorization decisions, to also perform and communicate a trust evaluation. Examples of such systems or nodes or devices may be, but are not limited to, a Certification Authority (CA) or a Validation Authority (VA); an IPSec GW; an Authentication and Authorization (AA) server, and the NRF. Further, the trust evaluation may, for example, be used in the responses sent back to the requesting entity, e.g. an NF or a TLS client, sent over existing standardized interfaces to enable access control decision-making. The trust evaluation may, for example, include evaluating the trustworthiness of a second entity and deciding whether to trust the second entity or not.

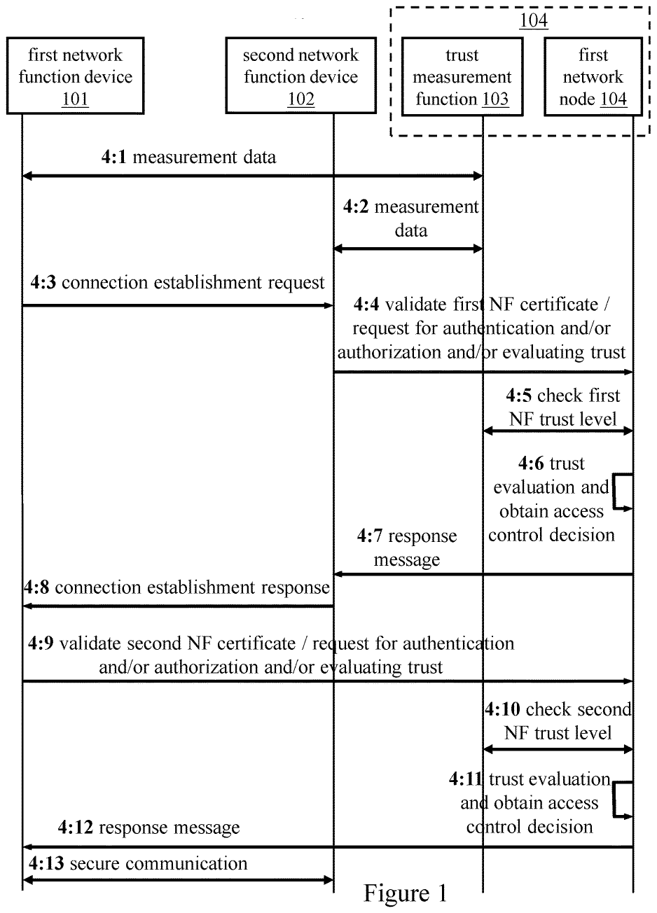

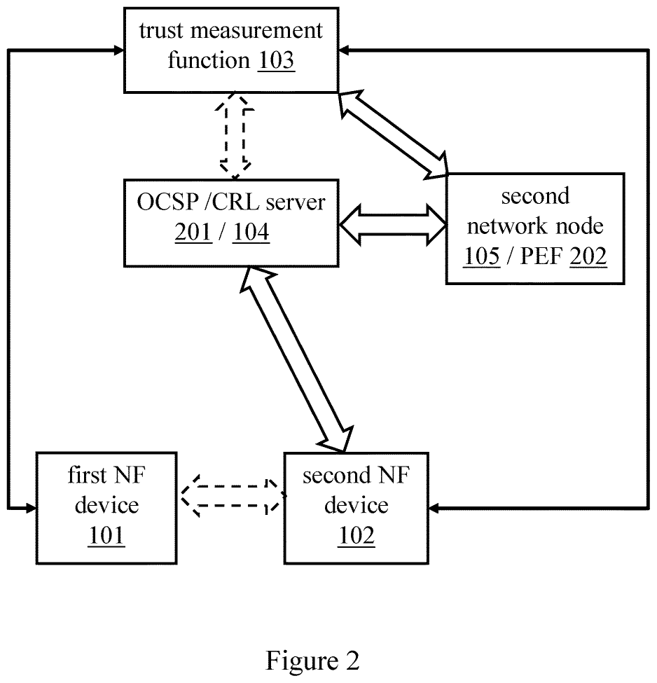

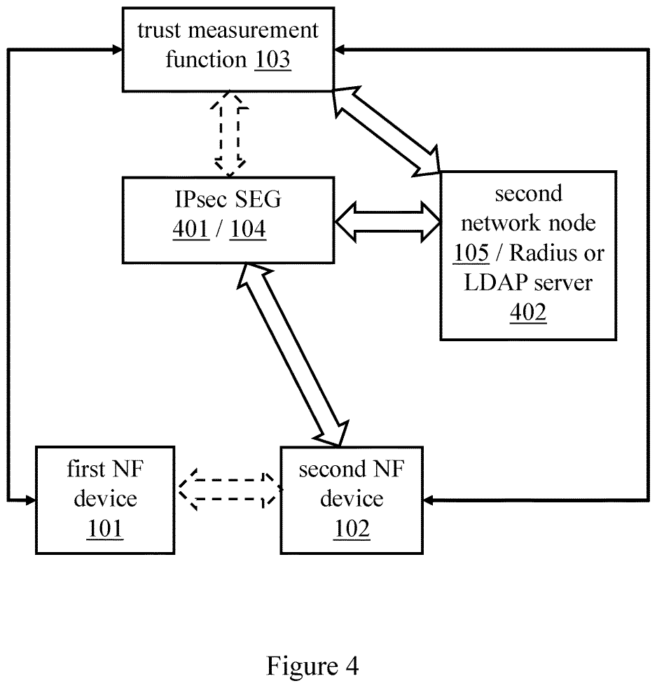

FIG. 1 is a signalling diagram depicting interaction between entities in a system according to an embodiment. More specifically, FIG. 1 illustrates a first NF device 101, a second NF device 102, a first network node 104 and a trust measurement function (TMF) 103 and the interaction between them which is detailed below. As will also be described later in this application with reference to FIGS. 2-5, the first network node 104 may, for example, be a OCSP/CRL server; an NRF; a IPsec Security Gateway (SEG) node (herein referred to as ‘IPsec SEG’); or a Remote Authentication Dial-In User Service (Radius)/Lightweight Directory Access Protocol (LDAP) server. Although not depicted in FIG. 1, a second network node may be included in the system, according to some embodiments. As will also be described later in this application with reference to FIGS. 2 and 4, the second network node may, for example, be a Policy Enforcement Function (PEF) or Radius/LDAP server.

An NF device as in FIG. 1 (for example the first NF device 101 and/or the second NF device 102), may, for example, refer to a functional block within a network infrastructure, which has well-defined external interfaces and a well-defined functional behavior. The NF device may be a virtual NF or a physical NF. The NF device may comprise one or more NF functionalities, for example one or more 5G NF functionalities. The NF device may be implemented as a network node or a physical hardware. Some examples of the 5G NFsinclude, but are not limited to: NRF, Access and Mobility Management function (AMF), Session Management function (SMF), User Plane Function (UPF), Policy Control Function (PCF), Authentication Server Function (AUSF), Unified Data Management (UDM), Application Function (AF), Network Exposure Function (NEF) and Network Slice Selection Function (NSSF).

The TMF 103 may refer to a hardware or a software unit executing a trust measurement algorithm (also referred to herein as ‘trust evaluation’). The TMF 103 may, for instance, be implemented in a network node containing a memory and a processor, the memory containing software instructions which when executed on the processor cause the network node to implement the trust measurement algorithm. There are different ways to implement the trust measurement algorithm. Identifying which trust measurement algorithm implementation to adopt depends on certain characteristics.

The trust measurement may, for example, be performed based on a trust score. A score-based measurement may include computation of a confidence level based on values (e.g. measurement data) from one or more data sources, recognizing that there may be various levels of trust between different entities, e.g. between the first NF device 101 and the second NF device 102.

In another example, trust measurement is performed based on one or more criteria. The criteria-based measurement may rely on a set of statically configured attributes that must be met before access is granted to a resource or an action is allowed to be performed. The action may, for example, be a connection establishment between the first NF device 101 and the second NF device 102.

As illustrated by step 4:1 and step 4:2 of FIG. 1, the NFs (i.e the first NF device 101 and the second NF device 102 respectively) may send measurement data to the TMF 103 for enabling measurement of trust or the determination of the trust score.

The measurement data may, for example, include at least one of the following: NF location, software capabilities (such as patch level, software versions), execution history of a software instance, configuration compliance information and the appropriate use of encryption techniques. The measurement data may further include at least one of: attestation level, EDR information and other metadata to determine the compliance with relevant security policies. Other examples of the measurement data include, but are not limited to, information about: the device (for example, Hardware/Software/Firmware versions), location, access network type, patch level of device, antivirus or threat database version. The measurement data may, for example, be obtained by software agents running on the device.

The NF device (e.g. the first NF device 101 and/or the second NF device 102) may respectively send the measurement data as log files, e.g. audit logging, according to standard procedures. The NF device (e.g. the first NF device 101 and/or the second NF device 102) may generate the different logs and send it to a centralized node in real time.

The NF device (e.g. the first NF device 101 and/or the second NF device 102) may periodically send such measurement data. The periodic sending of the measurement data by the NF device enables the TMF 103 to store and dynamically update the trust measurement for the NF device.

In some embodiments, a software agent running on the NF device (e.g. the first NF device 101 and/or the second NF device 102) may send the measurement data.

In an embodiment, the NF device (e.g. the first NF device 101 and/or the second NF device 102) sends the measurement data according to a Security Orchestration, Automation and Response (SOAR) procedure or a Security Information and Event Management procedure (SIEM). In other words, the NF device sends a SOAR/SIEM message comprising the measurement data.

In an embodiment, the TMF 103 requests the NF device to send the measurement data.

Referring to step 4:3 of FIG. 1, the first NF device 101 may want to communicate with the second NF device 102. For this reason, the first NF device 101 sends to the second NF device 102 a connection establishment request. The connection establishment request may, for example, be sent via a message such as a TLS message, e.g. “Client hello”. However, prior to establishing a secure connection with the first NF device 101 and/or prior to transmitting data, the second NF device 102 may want to establish that the first NF device 101 is trustworthy and not a malicious entity.

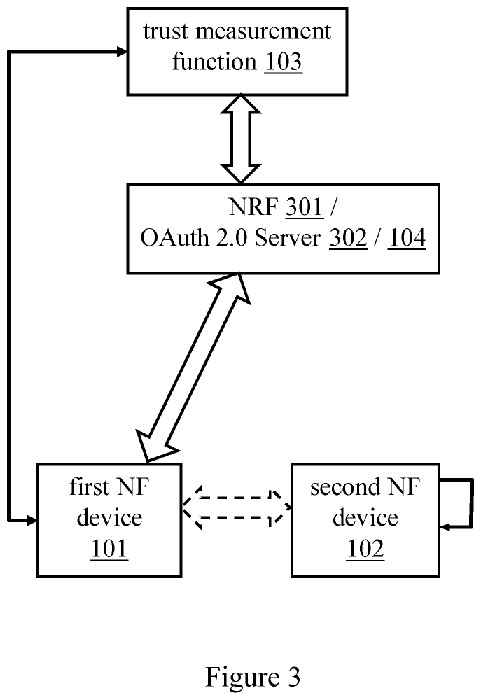

For this reason, the second NF device 102 may, for example, validate the first NF device 101 with a trusted node, e.g. the first network node 104, as illustrated by step 4:4 of FIG. 1. More specifically, the second NF device 102 may want to validate a security certificate or a security credential of the first NF device 101 with the trusted node. The second NF device 102 may, thus, request the first network node 104 to authenticate and/or authorize and/or evaluate trust of the first NF device 101. In other words, the second NF device 102 sends to the first network node 104, a request message comprising a request for authenticating and/or authorizing and/or evaluating trust of the first NF device 101. Alternatively (not shown in FIG. 1), instead of the second NF device 102, the first NF device 101 may send to the first network node 104, the request message comprising a request to authenticate and/or authorize and/or evaluate trust of the first NF device 101, as will be later described in relation to FIG. 3.

To provide a response to the request for authenticating and/or authorizing and/or evaluating trust, the first network node 104 may need information about the trust level of the first NF device 101. The information about trust level may, for example, be available at the TMF 103. The TMF 103 may regularly get measurement data from the NF device, e.g the first NF device 101 and/or the second NF device 102. The first network node 104 may, thus, communicate with the TMF 103 to obtain information about the trust level of the first NF device 101. In some embodiments, the TMF 103 is implemented in a node or a device different than the first network node 104. In some other embodiments, the TMF 103 is implemented in the first network node 104.

As illustrated by step 4:5 of FIG. 1, the first network node 104 checks with the TMF 103, the trust level of the first NF device 101. In other words, the first network node 104 sends to the TMF 103 a request message comprising a request for obtaining the trust level of the first NF device 101.

The TMF 103 then determines (for example computes or calculates) a trust score for the first NF device 101. The trust score may for example be regarded as a representation of the trust level of the first NF device 101. In an embodiment, the TMF 103 determines the trust score based on the measurement data received from the first NF device 101 as described above in relation to step 4:1 of FIG. 1. In an embodiment, the TMF 103 determines the trust score singularly wherein each request is assessed on individual basis without considering historic information about the NF device (e.g. the first NF device 101). In an embodiment, the TMF 103 determines the trust score contextually by taking the NF device's (e.g. the first NF device's 101) historic information into consideration.

In some embodiments, the TMF 103 first sends to the first NF device 101 a message comprising a request for the measurement data and then determines the trust score based on the latest measurement data. Alternatively to determining the trust score, the TMF 103 may directly retrieve from memory storage, a trust score of the first NF device 101 previously determined based on the measurement data.

The TMF 103 then provides either the determined trust score or the retrieved trust score to the first network node 104. The TMF 103 may provide this in a response message for example, an OCSP response message.

It may, however, be noted that existing protocol and procedures may be used by the TMF 103 and/or the first network node 104 to provide the information regarding the trust score. This is an advantage in that additional modification to existing interfaces is not needed to communicate the trust information resulting in simpler design of a secure network architecture.

In an embodiment, the TMF 103 does not determine the trust score of the first NF device 101 but instead sends, to the first network node 104, information enabling a determination of the trust score. Such information may for example include the measurement data of the first NF device 101. In such a case, the first network node 104 may itself determine the trust score of the first NF device 101.

Referring to step 4:6 of FIG. 1, the first network node 104 performs the trust evaluation and obtains an access control decision.

The first network node 104 performs the trust evaluation of the first NF device 101 based on at least the trust score. As an example, the trust score may fall under different ranges of confidence on a scale of 0 -100 wherein a low confidence may be attributed to a trust score less than 50. Similarly, a medium confidence may be attributed to a trust score in the range (51-79) and a high confidence in the range (>=80).

The trust evaluation based on trust score is used by the NF device (e.g. the second NF device 101) or the first network node 104, to make access control decisions for example, to establish a secure connection between the first network device 101 and the second network device 102 and further enable secure access to a specific resource in the network.

The first network node 104 determines or obtains the access control decision for the NF device (e.g. the first NF device 101 and/or the second network device 102). Determining or obtaining the access control decision may include performing at least one of: authentication, authorization and trust evaluation. In an embodiment, determining or obtaining the access control decision includes performing authentication and authorization based on trust evaluation.

In some embodiments, the first network node 104 obtains the access control decision from a second network node 105, 202, 402, as will be described later in the application in relation to FIG. 2 and FIG. 4. In such embodiments, a second network node may communicate with the TMF 103 to obtain the trust information, e.g. the trust score for the NF device, instead of the first network node 104.

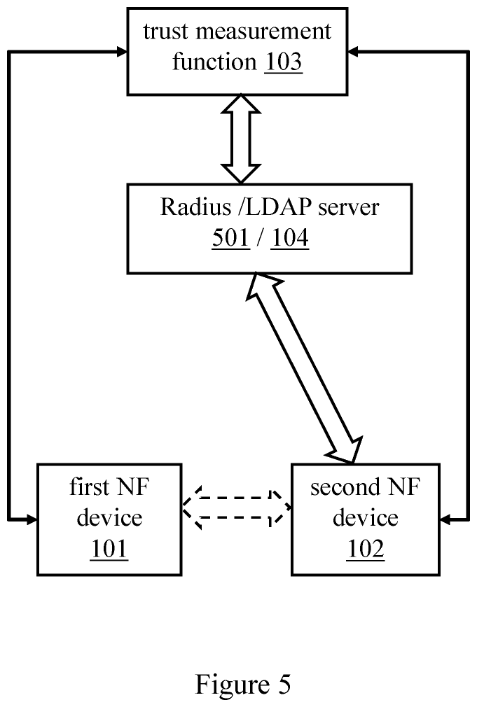

In some embodiments, the first network node 104 itself determines the access control decision, as will be described later in the application in relation to FIG. 3 and FIG. 5.

As described above with reference to steps 4:1 to 4:6, trust scores may be determined based on dynamically updated measurement data. Such trust scores enable an evaluation of confidence levels which may assist in taking access control decisions. In this way, the above-described authentication, authorization and trust evaluation may help provide a dynamic and granular access control mechanism.

As illustrated by step 4:7 of FIG. 1, the first network node 104 sends a response message to the second NF device 102. An example of such a message is an OCSP response message. Alternatively (not shown in FIG. 1), the first network node 104 sends a response message to the first NF device 101 as will be described later in relation to FIG. 3.

In some embodiments, the response message comprises the access control decision of the NF device (e.g. first NF device 101). The response message may also include a trust score of the NF device (e.g. the first NF device 101).

In some other embodiments, the response message indicates a trust score of the NF device (e.g. the first NF device 101) and not the access control decision. In such an embodiment, the second NF device 102 determines an access control decision based on trust evaluation based on the trust score. The response message may for example comprise the trust score, or may indicate the trust score explicitly or implicitly. The response message may for example include a parameter that indicates the value of the trust score.

In an embodiment, the response message further includes a result of the validation of a security certificate of the first NF device 101. The result of the validation may be determined based on the trust evaluation as described above.

In an embodiment, the response message is sent over standardized interfaces that are typically used for communicating authentication and/or authorization responses such as: interfaces supporting TLS/Datagram TLS protocols or interfaces supporting IPSec/IKE protocols. Additionally, the response message may include the access control decision and/or information on trust evaluation, e.g. the trust score, which response messages are sent over the standardized interfaces. Here is an advantage that existing interfaces may be used to deploy ZTA based access controls for the establishment of a secure communication network and thus enabling an easy integration of the solution of the invention within a standard network architecture, e.g. the 3GPP 5G network architecture.

In an embodiment, the first network node 104 sends to the second NF device 102 (or the first NF device 101) the access control decision via an indication comprised in the response message. The indication may, for example, be that the NF device (e.g. the first NF device 101) is authenticated and/or authorized. The indication may further include that the NF device (e.g. the first NF device 101) is trusted. The trust score of the NF device (e.g. the first NF device 101) may additionally be included in the response message.

Alternatively, the indication may be that the NF device (e.g. the first NF device 101) is not authenticated and/or not authorized. The indication may further include that the NF device (e.g. the first NF device 101) is not trusted. The trust score of the NF device (e.g. the first NF device 101) may additionally be included in the response message.

In some embodiments, the access control decision is indicated via a flag. An example of such a flag is CertificateHold indicating that the security certificate of the NF device (e.g. the first NF device 101) is revoked.

As illustrated by step 4:8, the second NF device 102 sends a connection establishment response to the first NF device 101 via a message such as a TLS message, e.g. “Server hello done”.

In an embodiment, the second NF device 102 takes decision on the connection establishment with the first NF device 101 based on at least the access control decision and/or based on the trust score comprised in the response message of step 4:7 of FIG. 1 and then, sends the connection establishment response message to the first NF device 101.

In an embodiment, the second NF device 102 sends, to the first NF device 101, a connection establishment response message indicating accepting the connection establishment request of the first NF device 101. This may be based on the access control decision indicating that the first NF device 101 is authorized and/or authenticated. This may be based on the access control decision indicating that the first NF device 101 is trusted based on the trust score exceeding a particular threshold value for the trust score.

In an embodiment, the second NF device 102 sends, to the first NF device 101, a connection establishment response message indicating rejecting the connection establishment request of first NF device 101. This may be based on the access control decision indicating that the first NF device 101 is not authorized and/or not authenticated. This may be based on the access control decision indicating that the first NF device 101 is not trusted due to the trust score not meeting a particular threshold value of trust score.

Based on the connection establishment response message indicating accepting the connection establishment request, the first NF device 101 may establish a secure communication with the second NF device 102 as illustrated by the step 4:13. The first NF device 101 may further send session data once the secure communication has been established.

Optionally, upon receiving the connection establishment response from the second NF device 102, the first NF device 101 sends a request for authenticating and/or authorizing and/or evaluating trust of the second NF device 102, as illustrated by step 4:9 of FIG. 1.

It may be noted the steps 4:9, 4:10, 4:11 and 4:12 of FIG. 1 follow the same procedure as the steps 4:4, 4:5, 4:6 and 4:7 of FIG. 1, respectively, in that the procedure of the steps 4:9 to 4:12 is executed for the first NF device 101 for the authentication and/or authorization and/or trust evaluation of the second NF device 102.

Once the first NF device 101 receives (at step 4:12) the response message that the second NF device 102 is authenticated and/or authorized and/or trusted, the first NF device 101 securely communicates with the second NF device 102, as illustrated by step 4:13 of FIG. 1. The first NF device 101 may, for instance, start securely communicating session data (and not signalling) with the second NF device 102 at step 4:13.

This ensures a secure communication between trust-evaluated entities, improving security in the communication network.

It will be appreciated that some of the steps in FIG. 1 could be useful also without the other steps. For example, the steps 4:1, 4:3, 4:4, 4:5, 4:6, 4:7, 4:8 could be employed to allow the second NF device 102 to know that it can trust the first NF device 101 and thus establish a secure communication with the first NF device 101, even if the other steps in FIG. 1 are omitted. For example, in some scenario, the first NF device 101 may already know for some reason that it can trust the second NF device 102, so there may be no need for the first NF device 101 to perform step 4:9 and to receive the response message at step 4:12 before securely communicating with the second NF device 102.

FIG. 2 illustrates a system according to an embodiment. The system comprises the first NF device 101, the second NF device 102, the TMF 103, the first network node 104 in the form of an OCSP/CRL server 201, and a second network node 105 in the form of a PEF 202.

According to FIG. 2, the second NF device 102 receives a connection establishment request from the first NF device 101. The second NF device 102 communicates with the OCSP/CRL server 201 to verify if a security certificate for the first NF device 101 is valid. That is, to verify if the identity of the first NF device 101 is valid. In other words, the second NF device 102 initiates the checking of the revocation status of the security certificate of the first NF device 101 by sending a request message comprising a request for authorization and/or authentication and/or evaluating trust to the OCSP/CRL server 201. The request message may for example be an OCSP/CRL message.

In an embodiment, the OCSP/CRL server 201 queries the TMF 103 for the trust evaluation score of the first NF device 101. The OCSP/CRL server 201 communicates with the PEF 202. The OCSP/CRL server 201 may communicate the trust score received from the TMF 103 to the PEF 202. Alternatively, in some embodiments, the PEF 202 itself communicates with the TMF 103 to obtain the trust information of the first NF device 101, e.g. the trust score.

In some embodiments, the PEF 202 determines an access control decision based on the trust score. In this case, the PEF 202 sends the access control decision to the OCSP/CRL server 201 for communicating to the second NF device 102.

In some other embodiments, the OCSP/CRL server 201 determines the access control decision. In such embodiments, the PEF 202 obtains the trust score from the TMF 103 and sends the obtained trust score to the OCSP/CRL server 201 to enable a determination of the access control decision.

The access control decision may, for instance, be a decision regarding allowing the NF device (e.g. the second NF device 102) to communicate with another NF device (e.g. the first NF device 101). The access control decision may, for instance, include a decision on at least one of the following: authentication, authorization and trust of the NF device (e.g. the first NF device 101 or the second NF device 102). The access control decision may, for example, be computed based on a trust evaluation procedure as described above in relation to Step 4:5-4:6 of FIG. 1.

If the access control decision indicates to deny access, then the OCSP/CRL server 201 responds to the second NF device 102 via an OCSP response message or a CRL response message comprising an indication that the security certificate of the first NF device 101 is revoked. The OCSP or CRL response message may, for example, include CRL reason codes and/or CRL extensions as described in RFC 5280 “Internet X.509 Public Key Infrastructure Certificate and Certificate Revocation List (CRL) Profile”, section 5.3.

In some embodiments, the indication of the access control decision is a reason flag such as certificateHold. The flag certificateHold indicates that the security certificate is on hold pending further action. The security certificate is treated as revoked but may be taken off hold in the future so that the certificate is active and valid again. The certificateHold reason flag may be comprised in the OCSP or CRL response message and sent if the first NF device 101 does not meet the trust evaluation requirements.

In some embodiments, the PEF 202 and/or the OCSP/CRL server 201 do not trust the trust score evaluation of the TMF 103 in which case the security certificate is revoked.

In an embodiment, the access control decision indicates to allow access. In this case, the OCSP/CRL server 201 sends an OCSP or a CRL response message to the second NF device 102 comprising an indication that the security certificate of the first NF device 101 is good or valid.

In an embodiment, the access control decision indicates that the security certificate is unknown. In this case, the OCSP/CRL server 201 sends an OCSP or a CRL response message to the second NF device 102 comprising an indication that the security certificate of the first NF device 101 is unknown.

In another embodiment, the OCSP/CRL server 201 includes the trust score in the response message to the second NF device 102. If the certificate is not revoked, the second NF device 102 may include the trust score when enforcing access policies towards the first NF device 101.

Once the first NF device 101 has been evaluated as trusted, the second NF device 102 sends a connection establishment response message to the first NF device 101 indicating accepting the connection establishment request of the first NF device 101. The first NF device 101 then establishes a secure connection with the second NF device 102 and sends the session data.

In some embodiments, before establishing the secure connection with the second NF device 102, the first NF device 101 may further check the revocation status of the second NF device's 102 security certificate using the OCSP/CRL server 201. This may then follow the same procedure as above as described in relation to trust evaluation of the first NF device 101 by the second NF device 102.

It may also be noted that, according to some embodiments, the request message comprising the request for authorization and/or authentication and/or evaluating trust as well the response message comprising the access control decision and/or the trust score, are exchanged according to standard procedures using at least a public key infrastructure, PKI, certificates.

It may also be noted that, according to some embodiments, the request message comprising the request for authorization and/or authentication and/or evaluating trust as well the response message comprising the access control decision and/or the trust score, are exchanged according to OCSP/CRL protocol.

FIG. 3 illustrates a system according to an embodiment. The system comprises the first NF device 101, the second NF device 102, the TMF 103, and a first network node 104 in the form of an NRF 301 or an OAuth 2.0 Server 302. More specifically, FIG. 3 illustrates an embodiment according to an OAuth 2.0 protocol which is described herein.

The OAuth 0 2.0 is an authorization protocol/procedure wherein a server such as an OAuth 2.0 server 302 or the NRF 301 has the authorization policies for the NF devices (e.g. the first NF device 101 and/or the second NF device 102) in its domain. When accessing a resource, a client (e. g the first NF device 101) typically obtains an access token from the OAuth 2.0 server 302, which access token is then used in an access request to the resource, e.g. a resource of the second NF device 102. The access token may include all the access policies so that the second NF device 102 does not need to check for the policies. Alternatively, the access token may be used by a resource of the second NF device 102 to further request for access policies from the OAuth 2.0 server 302. An example of an access token is a 3GPP rich token that include all policies so that the NF device (e, g. the second NF device 102) does not need to check with the NRF 301 for the policies. Another example of an access token is JSON Web Token (JWT).

According to FIG. 3, the first NF device 101 sends to the NRF 301 (or an OAuth 2.0 server 302) a request message comprising a request for authenticating and/or authorizing and/or evaluating trust of the first NF device 101. The request message includes a request for an access token from the NRF 301. The NRF 301 communicates with the TMF 103 to retrieve the trust evaluation information such as trust score of the first NF device 101.

Local policy enforcement in NRF 301 include the trust score as part of the access control procedure to provision the access token to the first NF device 101. If the trust evaluation requirements are met by the first NF device 101, the NRF 301 sends a response message, e.g. an OAuth 2.0 response message, comprising the access token to the first NF device 101. Thus, the NRF 301 or the OAuth 2.0 server 302 uses an access control procedure based on trust evaluation and that is using a token-based protocol, e.g. an OAuth 2.0 protocol.

The access control decision may, for example, include provisioning or granting the access token (e.g. a JWT access token), thereby indicating that the first NF device 101 is trusted and/or authorized and/or authenticated. The access token grant procedure may further be based on JWT Grant authentication procedure.

The trust evaluation requirements may, for example, be computed based on a trust evaluation procedure as described above in relation to Step 4:5-4:6 of FIG. 1.

The first NF device 101 then sends a connection establishment request to the second NF device 102. The connection establishment request includes the access token that was provided by the NRF 301 or the OAuth 2.0 server 302.

The second NF device 102 then validates the token and establishes the connection with the first NF device 101. Alternatively, the second NF device 102 validates the token and sends a connection establishment response message indicating accepting the connection establishment after which the first NF device 101 sets up a secure connection with second NF device 102 and sends the session data.

It may also be noted that, according to some embodiments, the request message comprising the request for authorization and/or authentication and/or evaluating trust as well the response message comprising the access control decision and/or the trust score, are exchanged according to OAuth 2.0 protocol.

FIG. 4 illustrates a system according to an embodiment. The system comprises the first NF device 101, the second NF device 102, the TMF 103, the first network node 104 in the form of an IPsec SEG 401 node, and a second network node 105 in the form of a Radius or LDAP server 402. According to the FIG. 4, an IKE procedure is used for performing authentication and key exchange. The IKE authentication procedure is used to communicate an authentication decision, e.g. in the form of yes or no, based on the trust level evaluation of the NF device (e.g. the first NF device 101).

According to FIG. 4, the IPsec SEG 401 node is commonly used to terminate IPsec sessions from Radio Access Network (RAN) network functions (e.g. the first NF device 101 and the second NF device 102). The second NF device 102 receives a connection establishment request from the first NF device 101. The second NF device 102 sends a request message, e.g. an IKE/IPsec request message, comprising a request for authorization and/or authentication and/or evaluating trust to the IPsec SEG 401. In an embodiment, the IPsec SEG 401 communicates with the Radius or LDAP server 402 to authenticate and/or authorize and/or perform trust evaluation of the RAN network function device (e.g. the first NF device 101 and/or the second NF device 102). In other words, the IPsec SEG 401 uses an access control procedure based on trust evaluation and that is using Internet Key Exchange (IKE) authentication.

In some embodiments the IPsec SEG 401 communicates with the TMF 103 and obtains the trust score for the NF (e.g. the first NF device 101). The IPsec SEG then sends the trust score of the NF (e.g. the first NF device 101) to the Radius or LDAP sever 402.

In some other embodiments, the Radius or the LDAP server 402 itself communicates with the TMF 103 and obtains the trust score 103 from the TMF 103. In such embodiments, the Radius or the LDAP server 402 sends the trust score to the IPsec SEG 401 to enable a determination of the access control decision.

The radius or the LDAP server 402 or the IPsec SEG 401 then determines (for example computes) the access control decision based on at least the trust score. The access control decision may, for example, be computed based on a trust evaluation procedure as described above in relation to Step 4:5-4:6 of FIG. 1.

The Radius or the LDAP server 402 sends to the IPsec SEG 401 a response message, e.g. IKE/IPSec response message, comprising the access control decision. In some embodiments, the Radius or the LDAP server 402 further includes the trust score in the response message.

The access control decision may, for example, indicate denying access or allowing access. The access control decision may, for example, include an indication that the NF device (e.g. the first NF device 101) is not authenticated and/or not trusted. The access control decision may, for example, include an indication that the NF (e.g. the first NF device 101) is authenticated and/or is trusted. Based on the access control decision performed based on trust evaluation, the IPsec SEG 401 may send a response message indicating a rejection of request to establish security associations over the IKE.

The IPsec SEG 401 responds to the requesting NF device (e.g. the second NF device 102), the access control decision evaluated based on trust evaluation, according to the IKE authentication procedure. In other words, the IPsec SEG 401 sends an IKE response message comprising the access control decision evaluated based on trust evaluation. The IPsec SEG 401 may further include the trust score in the IKE response message to the NF device (e.g. the second NF device 102).

The NF device (e.g. the second NF device 102) receives the access control decision and based on the access control decision either accepts or denies the connection request from the other NF device (e.g. the first NF device 101).

In some embodiments, the second NF device 102 receives the trust score information and evaluates the authentication result for the first NF device 101 based on the trust score. Based on the evaluation, the second NF device 102 sends, to the first NF device 101, a connection establishment response message indicating either a deny or an allow access to the connection request from the first NF device 101.

If the connection establishment response message indicates accepting the connection establishment, the first NF device 101 sets up a secure connection with second NF device 102 and sends the session data.

It may also be noted that, according to some embodiments, the request message comprising the request for authorization and/or authentication and/or evaluating trust as well the response message comprising the access control decision and/or the trust score, are exchanged according to IKE/IPSec protocol.

FIG. 5 illustrates a system according to an embodiment. The system comprises the first NF device 101, the second NF device 102, the TMF 103, and the first network node 104 in the form of a Radius or LDAP server 501.

According to FIG. 5, the second NF device 102 receives a connection establishment request from the first NF device 101. The second NF device 102 sends a request message comprising a request for authorization and/or authentication and/or evaluating trust to Radius/LDAP server 501. The Radius/LDAP server 501 performs access control procedure based on trust evaluation and that is using Operation and Management (OAM) procedures. The Radius/LDAP server 501 performs at least the authentication and validation of credentials. The Radius/LDAP server 501 communicates with the TMF 103 to obtain trust information, e.g. the trust score, about the first NF device 101.

The Radius/LDAP server 501 determines the access control decision based on the trust information. The access control decision may, for example, be determined based on a trust evaluation procedure as described above in relation to Step 4:5-4: 6 of FIG. 1. The access control decision may, for example, indicate denying access or allowing access for connection establishment with the first NF device 101. The access control decision may, for example, include an indication that the NF device (e.g. the first NF device 101) is not authenticated and/or not authorized and/or not trusted. The access control decision may, for example, include an indication that the NF device (e.g. the first NF device 101) is authenticated and/or is trusted and/or is authorized. The access control decision may, additionally, be based on whether the trust evaluation from the TMF 103 may itself be trusted. In the example scenario that the trust evaluation of the TMF 103 is not trusted, the access control decision may, for example, indicate denying access and sending a response message indicating that the first NF device 101 could not be authorized based on the trust evaluation.

The Radius/LDAP server 501 sends a response message, e.g. an OAM message, to the second NF device 102 regarding the connection establishment with the first NF device 101. The response message includes the access control decision computed based on the trust evaluation. Thus, the Radius/LDAP server 501 uses an access control procedure based on trust evaluation and that is using an OAM protocols/procedures.

In some embodiments, the response message includes a trust score of the first NF device 101. The second NF device 102 may then perform a trust evaluation of the first NF device 101 and decide to establish a secure connection with the first NF device 101.

The response message may, for example, be an Authorization OK message to indicate that the first NF device 101 is trusted. The response message may, for example, be an Authorization Not OK message to indicate that the first NF device 101 is not trusted.

Upon receiving the response message comprising access control decision from the Radius/LDAP server 501 or upon determining the access control decision using the trust score, the second NF device 102 sends a connection establishment response message to the first NF device 101. The connection establishment response message may indicate accepting or denying the connection establishment request earlier sent by the first NF device 101.

If the connection establishment response message indicates accepting the connection establishment, the first NF device 101 sets up a secure connection with second NF device 102 and sends the session data.

It may further be noted that although the procedures in FIGS. 2, 4 and 5 have been described from the point of view of the second NF device 102 requesting for an authentication and/or authorization and/or trust evaluation of the first NF device 101, it may also be that the first NF device 101 requests for the second NF device 102 to be authenticated and/or authorization and/or trust evaluated. Even in this case, the procedures described in FIGS. 2, 4 and 5 still apply but from the perspective of the first NF device 101 requesting for authentication and/or authorization and/or trust evaluation of the second NF device 102. Such a request by the first NF device 101 may, for example, be made after the second NF device 102 has authenticated and/or authorized and/or trust evaluated the first NF device 101 and the second NF device 102 has sent a connection establishment response message comprising the access control decision allowing for the connection establishment with the first NF device 101. A similar approach as above, applies to procedure described in FIG. 3 from the point of view of the second NF device 102 requesting for an authentication and/or authorization and/or trust evaluation of the second NF device 102 before proceeding to establish a secure connection with the first NF device 101.

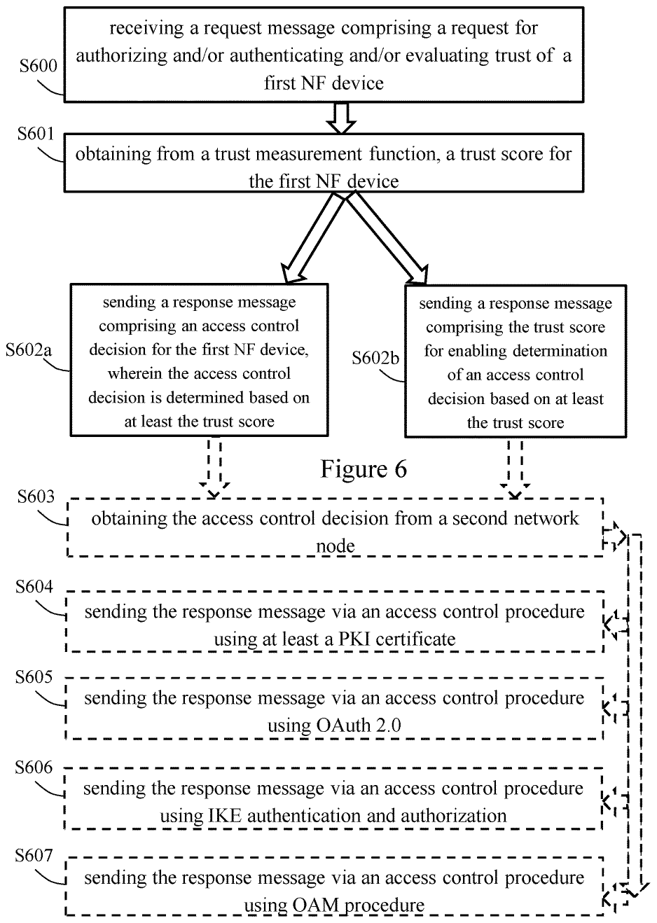

FIG. 6 illustrates a method performed by the first network node 104 according to an embodiment. The method comprises:
At step S600, receiving a request message comprising a request for authorizing and/or authenticating and/or evaluating trust of a first NF device 101;
At step S601, obtaining from a trust measurement function, TMF 103, a trust score for the first NF device 101;

The method further comprises:
At step S602a sending a response message comprising an access control decision for the first NF device 101, wherein the access control decision is determined based on at least the trust score;
   or
At step S602b, sending a response message comprising the trust score of the first NF device 101 for enabling determination of an access control decision based on at least the trust score.

Optionally, the method further comprises one or more of the following:
At step S603, obtaining the access control decision from a second network node.
At step S604, sending the response message via an access control procedure using at least a public key infrastructure, PKI, certificate.
At step S605, sending the response message via an access control procedure using OAuth 2.0.
At step S606, sending the response message via an access control procedure using Internet Key Exchange, IKE, authentication and authorization.
At step S607, sending the response message via an access control procedure using OAM procedure.

As can be seen above, step 4:4 of FIG. 1 is an example of step S600 of FIG. 6. Similarly, steps 4:5 and 4:6 of FIG. 1 are examples of step S601 of FIG. 6. Similarly, step 4:7 of FIG. 1 is an example of step S602a and step S602b of FIG. 6. Furthermore, the request message comprising a request for authorizing and/or authenticating and/or evaluating trust of a first NF device 101 received at step S600 may be received from either the first NF device 101 or the second NF device 102. For example, in the embodiments described in relation to FIGS. 2, 4 and 5, the request message is received from the second NF device 102 while in the embodiments described in relation to FIG. 3, the request message is received from the first NF device 101.

According to one or more embodiments, the request message is an OCSP message or a CRL message.

According to one or more embodiments, the request message is an OAuth 2.0 message.

According to one or more embodiments, the request message is an IKE/IPsec message.

According to one or more embodiments, the request message is an OAM message.

According to one or more embodiments, the response message is a OCSP message or a CRL message.

According to one or more embodiments, the response message is an OAuth 2.0 message.

According to one or more embodiments, the response message is an IKE/IPsec message.

According to one or more embodiments, the response message is an OAM message.

According to one or more embodiments, the response message comprising the access control decision sent at step S602a or the response message comprising the trust score sent at step S602b, enables the establishment of a secure connection between the first NF device 101 and the second NF device 102.

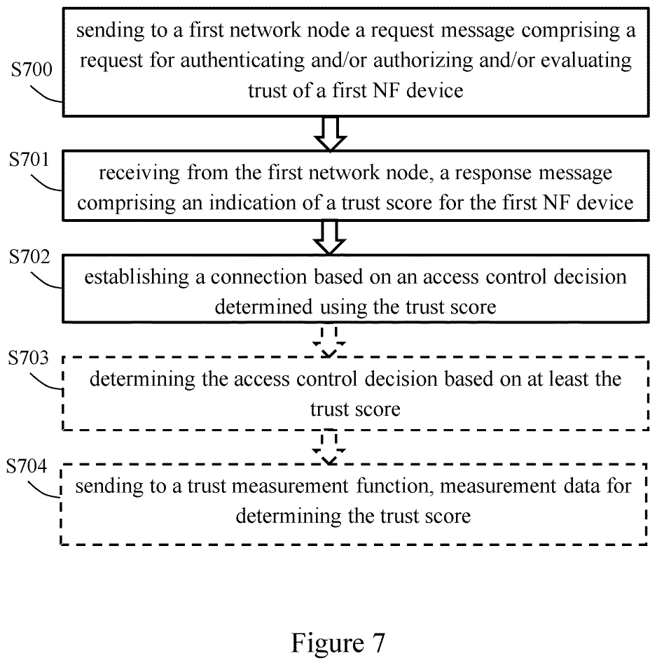

FIG. 7 illustrates a method performed by a network function device, e.g. the first NF device 101 or the second NF device 102, according to an embodiment.

The method comprises:
At step S700, sending to a first network node 104 a request message comprising a request for authenticating and/or authorizing and/or evaluating trust of a first NF device 101;
At step S701, receiving from the first network node 104, a response message comprising an indication of a trust score for the first NF device 101; and
At step S702, establishing a connection based on an access control decision determined using the trust score.

Optionally, the method comprises one or more of the following:
At step S703, determining the access control decision based on at least the trust score.
At step S704, sending to the trust measurement function, measurement data for determining the trust score.

As can be seen above, step 4:4 of FIG. 1 is an example of step S700 of FIG. 7. Similarly, step 4:7 of FIG. 1 is an example of step S701 of FIG. 7. Similarly, step 4:7 of FIG. 1 is an example of step S701 of FIG. 7.

According to one or more embodiments, at step S702, the connection is established between the first NF device 101 and the second NF device 102. In more detail, if the first NF device 101 performs the method illustrated by FIG. 7, then the connection is established with the second NF device 102. On the other hand, if the second NF device 102 performs the method illustrated by FIG. 7, then the connection is established with the first NF device 101.

It may be noted that the connection established at step S702 is a secure connection established between entities, i.e. the first NF device 101 and the second NF device 102, that have been validated as being trusted. In other words, a secure connection may be established based on a positive indication of the access control decision.

In some embodiments, step S704 is performed prior to step S701 or step S700.

In one or more embodiments, the NF device performing the method illustrated in FIG. 7 is a first NF device 101.

In one or more embodiments, the NF device performing the method illustrated in FIG. 7 is a second NF device 102.

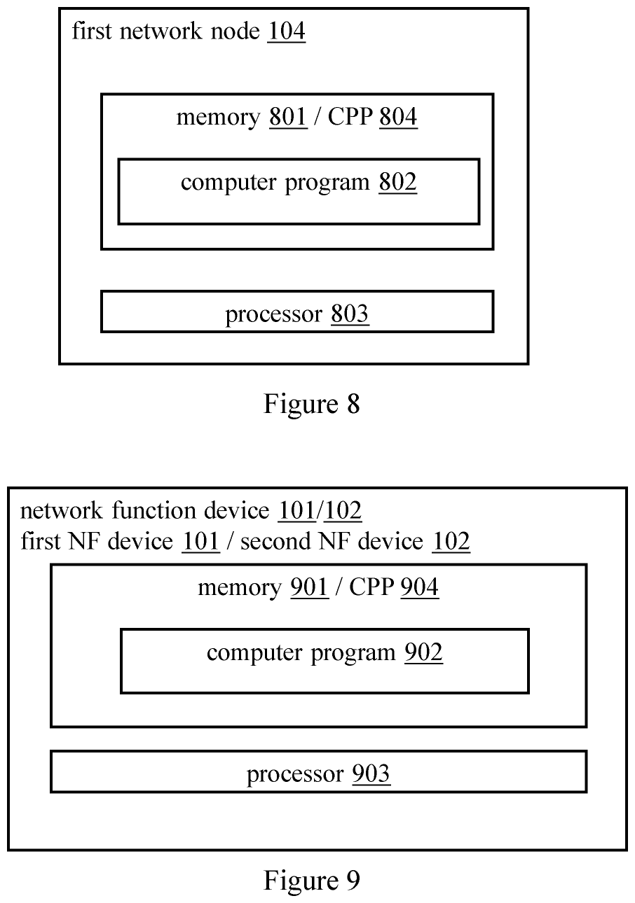

Referring to FIG. 8, the first network node 104 may have storage and/or processing capabilities. The first network node 104 may be configured to control any one of the methods and/or processes described herein and/or to cause such methods, and/or processes to be performed. Processor 803 corresponds to one or more processors for performing the first network node 104 functions described herein. The first network node 104 includes memory 801 or computer readable storage medium 801 that is configured to store data, programmatic software code and/or other information described herein. In particular, in addition to a traditional processor and memory, the first network node 104 may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 803 may be configured to access, for example, write to and/or read from the memory 801 or the computer readable storage medium 801, which may comprise any kind of volatile and/or non-volatile memory, for example, cache and/or buffer memory and/or RAM (Random Access Memory) and/or ROM (Read-Only Memory) and/or optical memory and/or EPROM (Erasable Programmable Read-Only Memory).

The memory 801 or the computer readable storage medium 801 may include instructions which, when executed by the one or more processors 803, cause the first network node 104 to perform the processes described herein with respect to the first network node 104, for example method(s) described in relation to FIG. 6. The instructions may be software (SW) or a computer program associated with the first network node 104.

Thus, the first network node 104 may further comprise SW or a computer program, which is stored in, for example, the memory 801 or the computer readable storage medium 801 at the first network node 104, or stored in external memory, for example, database, accessible by first network node 104. The SW or computer program may be executable by the one or more processors 803.

A computer program product (CPP) 804 in the form of a computer readable storage medium 801 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 803. Computer readable storage medium 801 may store any suitable instructions, data or information, including a computer program, software, an application including one or more of logic, rules, code, tables, etc. and/or other instructions capable of being executed by one or more processors 803. Computer readable storage medium 801 may be used to store any calculations made by one or more processors 803. In some embodiments, one or more processors 803 and the memory/computer readable storage medium 801 may be considered to be integrated.

Referring to FIG. 9, the NF device, e.g. the first NF device 101 or the second NF device 102, according to FIG. 9 may have storage and/or processing capabilities. The NF device, e.g. the first NF device 101 or the second NF device 102, may be configured to control any one of the methods and/or processes described herein and/or to cause such methods, and/or processes to be performed. Processor 903 corresponds to one or more processors for performing NF device, e.g. the first NF device 101 or the second NF device 102, functions described herein. The NF device, e.g. the first NF device 101 or the second NF device 102, includes memory 901 or computer readable storage medium 901 that is configured to store data, programmatic software code and/or other information described herein. In particular, in addition to a traditional processor and memory, the NF device, e.g. the first NF device 101 or the second NF device 102, may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 903 may be configured to access, for example, write to and/or read from the memory 901 or the computer readable storage medium 901, which may comprise any kind of volatile and/or non-volatile memory, for example, cache and/or buffer memory and/or RAM (Random Access Memory) and/or ROM (Read-Only Memory) and/or optical memory and/or EPROM (Erasable Programmable Read-Only Memory).

The memory 901 or the computer readable storage medium 901 may include instructions which, when executed by the one or more processors 903, cause the NF device, e.g. the first NF device 101 or the second NF device 102, to perform the processes described herein with respect to the NF device, e.g. the first NF device 101 or the second NF device 102, for example method(s) described in relation to FIG. 7. The instructions may be software (SW) or computer program associated with the NF device, e.g. the first NF device 101 or the second NF device 102.

Thus, the NF device, e.g. the first NF device 101 or the second NF device 102, may further comprise software or a computer program, which is stored in, for example, the memory 901 or the computer readable storage medium 901 at the NF device, e.g. the first NF device 101 or the second NF device 102, or stored in external memory, for example, database, accessible by the NF, e.g. the first NF device 101 or the second NF device 102. The SW or computer program 902 may be executable by the one or more processors 903.

A computer program product (CPP) 904 in the form of a computer readable storage medium 901 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 903. Computer readable storage medium 901 may store any suitable instructions, data or information, including a computer program, software, an application including one or more of logic, rules, code, tables, etc. and/or other instructions capable of being executed by one or more processors 903. Computer readable storage medium 901 may be used to store any calculations made by one or more processors 903. In some embodiments, one or more processors 903 and the memory/computer readable storage medium 901 may be considered to be integrated.

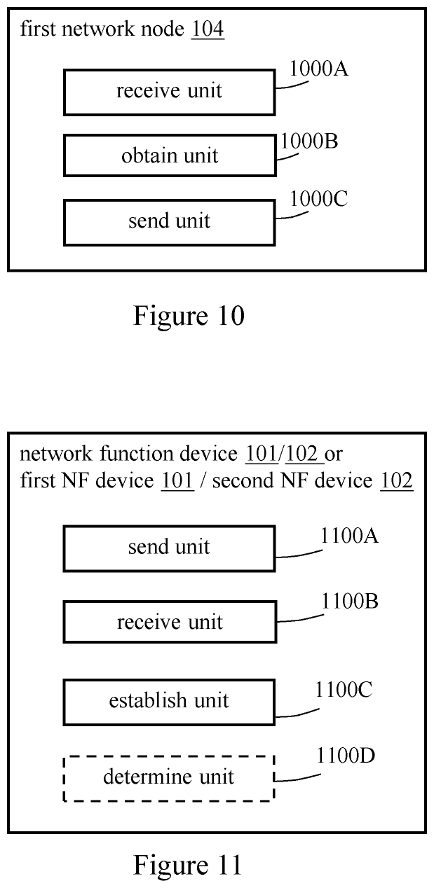

FIG. 10 discloses a first network node 104 which comprises functional units 1000A, 1000B, and 1000C. Referring to FIG. 10, in general terms, each functional unit 1000A, 1000B, and 1000C, i.e. the receive unit 1000A, the obtain unit 1000B and the send unit 1000C, may be implemented in hardware or in software. Preferably, one or more or all functional units 1000A-1000C may be implemented by the one or more processors 803, possibly in cooperation with the computer readable storage medium 801 or the memory 801. The one or more processors 803 may thus be arranged to fetch instructions, from the computer readable storage medium 801 or the memory 801, as provided by a functional unit 1000A-1000C and to execute these instructions, thereby performing any steps of the first network node 104 as disclosed herein, for example steps disclosed in relation to FIG. 6.

More specifically, in an embodiment, the receive unit 1000A is configured to perform step S600 of FIG. 6. Further, the obtain unit 1000B is configured to perform step S601 of FIG. 6 and optionally, step S603 of FIG. 6. Furthermore, the send unit 1000C is configured to perform the steps S602a or S602b of FIG. 6 and optionally, steps S604, S605, S606 and S607.

FIG. 11 discloses a network function device 101,102, e.g. the first network function device 101 or the second network function device 102, which comprises functional units 1100A, 1100B and 1100C. Referring to FIG. 11, in general terms, each functional unit 1100A, 1100B, 1100C and optionally, 1100D i.e. the send unit 1100A, the receive unit 1100B, the establish unit 1100C and the determine unit 1100D (optional unit), may be implemented in hardware or in software. Preferably, one or more or all functional units 1100A-1100D may be implemented by the one or more processors 903, possibly in cooperation with the computer readable storage medium 901 or the memory 901. The one or more processors 903 may thus be arranged to fetch instructions, from the computer readable storage medium 901 or the memory 901, as provided by a functional unit 1100A-1100D and to execute these instructions, thereby performing any steps of the NF device 101, 102, e.g. the first NF device 101 or the second NF device 102, as disclosed herein, for example steps disclosed in relation to FIG. 7. More specifically, in an embodiment, the send unit 1100A is configured to perform steps S700 of FIG. 7. In an embodiment, the receive unit 1100B is configured to perform step S701 and optionally step S704 of FIG. 7. In an embodiment, the establish unit 1110C is configured to perform step S702 of FIG. 7. In an embodiment, the determine unit 1110D (optional unit) is configured to perform step S703 of FIG. 7.

1.-41. (canceled)

42. A method performed by a first network node of a communication network, the method comprising:
receiving a request message comprising a request for one or more of the following operations with respect to a first network function (NF) device of the communication network: authorizing, authenticating, and evaluating trust;
obtaining trust score for the first NF device from a trust measurement function (TMF) of the first network node, wherein the trust score of the first NF device is determined by the TMF based on measurement data of the first NF device; and
sending a response message comprising one of the following information:
the trust score of the first NF device, or
an access control decision for the first NF device, wherein the access control decision is based on the trust score.

43. The method according to claim 42, wherein the information in the response message is a basis for establishment of a secure connection between the first NF device and a second NF device of the communication network.

44. The method according to claim 43, wherein the request message is received according to one of the following:
before connection establishment between the first NF device and the second NF device, or
after connection establishment between the first NF device and the second NF device.

45. The method according to claim 42, further comprising obtaining the access control decision from a second network node of the communication network.

46. The method according to claim 45, wherein the second network node is a Policy Enforcement Function (PEF).

47. The method according to claim 42, wherein the access control decision indicates one or more of the following:
whether the first NF device is authenticated,
whether the first NF device is authorized for accessing the communication network, and
whether the first NF device is trusted for accessing the communication network.

48. The method according to claim 42, wherein the first network node is an Online Certificate Status Protocol (OCSP) or a Certificate Revocation List (CRL) server.

49. The method according to claim 42, wherein the response message is sent via an access control procedure using a public key infrastructure (PKI) certificate.

50. The method according to claim 42, wherein the measurement data of the first NF device, on which the trust score is based, includes one or more of the following: audit log files, boot measurement, attestation state, and Endpoint Detect Response (EDR) information.

51. A method performed by a network function (NF) device of a communication network, the method comprising:
sending, to a first network node of the communication network, a request message comprising a request for one or more of the following operations with respect to a first NF device of the communication network: authorizing, authenticating, and evaluating trust;
receiving from the first network node a response message comprising one of the following information:
a trust score of the first NF device, wherein the trust score is determined by a trust measurement function (TMF) of the first network node based on measurement data of the first NF device; or
an access control decision for the first NF device, wherein the access control decision is based on the trust score; and
establishing a connection based on the information received in the response message.

52. The method according to claim 51, further comprising determining the access control decision based on the received trust score, wherein establishing the connection is based on the determined access control decision.

53. The method according to claim 51, further comprising sending at least part of the measurement data for the first NF device, on which the trust score is based, to the TMF of the first network node.

54. The method according to claim 51, wherein the access control decision indicates one or more of the following:
whether the first NF device is authenticated,
whether the first NF device is authorized for accessing the communication network, and
whether the first NF device is trusted for accessing the communication network.

55. The method according to claim 51, wherein the measurement data of the first NF device, on which the trust score is based, includes one or more of the following: audit log files, boot measurement, attestation state, and Endpoint Detect Response (EDR) information.

56. A first network node configured for operation in a communication network, the first network node comprising a memory and a processor, wherein the memory includes instructions which when executed by the processor cause the first network node to:
receive a request message comprising a request for one or more of the following operations with respect to a first network function (NF) device of the communication network: authorizing, authenticating, and evaluating trust;
obtain trust score for the first NF device from a trust measurement function (TMF) of the first network node, wherein the trust score of the first NF device is determined by the TMF based on measurement data of the first NF device; and
send a response message comprising one of the following:
the trust score of the first NF device, or
an access control decision for the first NF device, wherein the access control decision is based on the trust score.

57. The first network node according to claim 56, wherein the access control decision indicates one or more of the following:
whether the first NF device is authenticated,
whether the first NF device is authorized for accessing the communication network, and
whether the first NF device is trusted for accessing the communication network.

58. The first network node according to claim 56, wherein one or more of the following applies:
the first network node is an Online Certificate Status Protocol (OCSP) or a Certificate Revocation List (CRL) server; and
the response message is sent via an access control procedure using a public key infrastructure (PKI) certificate.

59. The first network node according to claim 56, wherein the measurement data of the first NF device, on which the trust score is based, includes one or more of the following: audit log files, boot measurement, attestation state, and Endpoint Detect Response (EDR) information.

60. Non-transitory, computer-readable medium storing computer-executable instructions that, when execute by a processor of a first network node configured to operate in a communication network, cause the first network node to perform the method of claim 42.

61. Non-transitory, computer-readable medium storing computer-executable instructions that, when execute by a processor of a network function (NF) device configured to operate in a communication network, cause the NF device to perform the method of claim 51.
